(19) United States
(12) Patent Application Publication
(10) Pub. No.: US 2023/0063937 A1
(43) Pub. Date: Mar. 2, 2023

(54) MOBILE SHOWROOM

(71) Applicant: Aardvark Event Logistics, Inc., Conshohocken, PA (US)

(72) Inventor: Lawrence W. Borden, Huntingdon Valley, PA (US)

(21) Appl. No.: 17/897,165

(22) Filed: Aug. 28, 2022

Related U.S. Application Data
(63) Continuation-in-part of application No. 29/805,403, filed on Aug. 26, 2021.
(60) Provisional application No. 63/241,783, filed on Sep. 8, 2021.

(51) Int. Cl. B60P 3/025; B60J 1/10; B60J 5/04; B62D 29/00; G09F 21/04

(52) U.S. Cl. CPC B60P 3/0255; B60J 1/10; B60J 5/048; B62D 29/00; G09F 21/048

(57) ABSTRACT

A mobile showroom vehicle has solid walls and glass panels and a glass door, and is configured to display a couch in a living room setting. The couch is placed against the opaque solid walls at a corner of the showroom, and the glass door and glass panels are positioned so that the couch is visible through the glass door and panels from outside the showroom.

### RELATED APPLICATIONS

This application is a continuation-in-part of U.S. Design Appl. No. 29/805,403, filed Aug. 26, 2021, and claims the benefit of priority of U.S. Provisional Application No. 63/241,783, filed on Sep. 8, 2021, the content of which is relied upon and incorporated herein by reference in its entirety.

### BACKGROUND

Over the years, various designs have been made for vehicles to be used for showrooms and advertising of products and/or services. For instance, U.S. Pat. No. 7,287,349 shows an advertising vehicle, U.S. Pat. No. 6,585,305 shows a showroom advertising vehicle, and U.S. Pat. No. 4,019,773 shows a showcase and advertising vehicle, and U.S. Pat. No. 10,269,273 shows a mobile showroom and advertising system.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a right-side perspective view of an exemplary mobile showroom according to one example, with the door in the opened position;

FIGS. 2(a), 2(b), 2(c) are right-side views of the mobile showroom of FIG. 1 with the door in the closed position;

FIGS. 3(a), 3(b), 3(c) are rear right-side perspective views of the mobile showroom of FIG. 1;

FIG. 4(a) is rear left-side perspective of the mobile showroom of FIG. 1;

FIG. 4(b) is a rear plan view of the mobile showroom of FIG. 1;

FIG. 4(c) is a driver-side view of the mobile showroom;

FIG. 5 is a left-side plan view of the mobile showroom of FIG. 1;

FIG. 6(a) is a top view of the mobile showroom of FIG. 1, showing furniture at the interior; and

FIG. 6(b) is a top view of the mobile showroom of FIG. 1, with the top removed to show various furniture arrangements in the interior of the vehicle.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

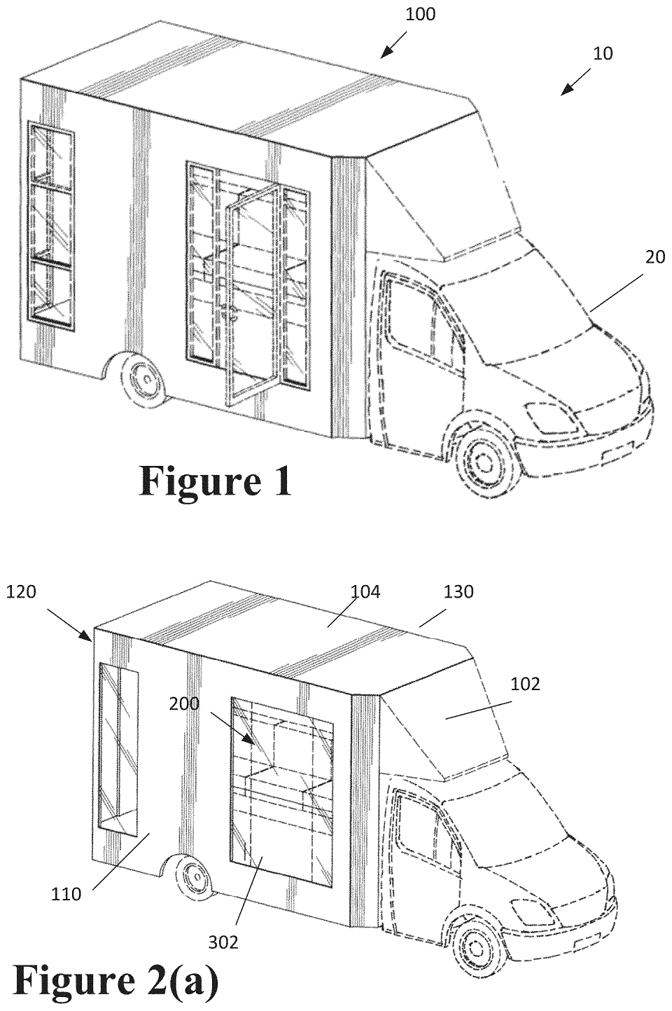

Turning to the drawings, FIGS. 1-6 show one example embodiment of a mobile showroom system 10 in the form of a vehicle having a chassis or cab 20 and a vehicle body 100. The cab 20 houses the motor and vehicle driver and passengers and is at the front of the system 10. The vehicle body 100 is mobile and can be transported by the cab 20. Thus, the vehicle body 100 includes wheels and other convention transportation elements. The vehicle body 100 houses the showroom 200.

In the example embodiment shown in the figures, the vehicle body 100 has both viewing mechanisms or viewing features 300 and structural mechanisms or structural features 400. The viewing features 300 enable a customer to view the interior of the showroom 200 of the vehicle body 100 from outside of the vehicle body and permit external light to enter the interior of the vehicle body. The structural features 400 provide sufficient structure for the interior of the vehicle body 100 to resemble a living space that is furnished, here shown as a den or living room having furniture items such as a couch, table, and television. Accordingly, the vehicle body 100 is configured so that the interior of the showroom 200 resembles a living space, yet is viewable from outside the vehicle to function as a promotional vehicle. That arrangement enables the product or display item being displayed, here a couch having three (3) units to sit three (3) persons and with two armrests, to be shown in a realistic setting that is viewable from outside the vehicle as well as inside the vehicle. Because the showroom interior can be viewed from outside of the vehicle, it attracts customers to the product being displayed, and entices those customers to enter the vehicle. However, the vehicle body 100 also has sufficient structure so that the showroom interior actually resembles a realistic living space so that customers can see the product being displayed in a setting that resembles their own living space.

The vehicle body 100 has an elongated rectangular or cuboid shape with a front or front side 102, a right side or passenger side 110, a rear or rear side 120, a left side or driver side 130, a top or top side 104, and a bottom or bottom side 106. Each side 102, 104, 106, 110, 120, 130 can be a thin flat wall or panel, but with sufficient thickness and strength to form a wall of the vehicle body 100. The bottom 106 can be even sturdier to support the weight of product and people inside the vehicle body 100. The right side 110, left side 130, top 104 and bottom 106 can have an elongated rectangular shape. The front 102, right side 110, rear 120, and left side 130 are positioned substantially vertical and the front 102 and rear 120 are substantially perpendicular to the left and right sides. The top 104 and bottom 106 are positioned substantially horizontal and are substantially perpendicular to the front, right, rear, and left sides 102, 110, 120, 130.

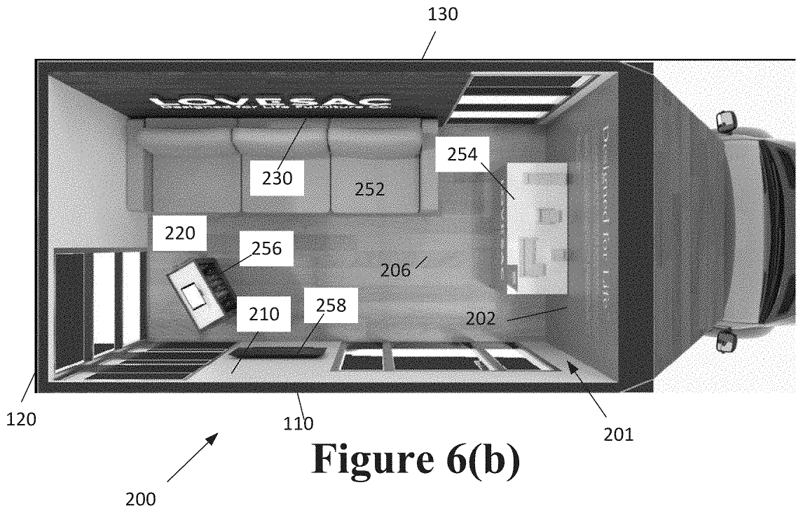

The showroom or showroom assembly 200 is best shown in FIG. 6(b). As illustrated, the showroom assembly has a showroom front side 202, showroom right side 210, showroom rear side 220, showroom left side 230, showroom bottom or bottom side 206, and the showroom top or top side 204. The showroom bottom 206 forms the floor of the showroom apparatus 200 and the showroom top forms the ceiling of the showroom apparatus 200. The showroom sides 202, 210, 220, 230, 206, 204 define an interior space or enclosure 201.

The showroom sides 202, 210, 220, 230, 204, have finished inside or interior surfaces, such as drywall that is then painted, paneled, or wall-papered. And the floor can also have a finished inside surface, such as carpeting or flooring. In one embodiment, the showroom sides 202, 210, 220, 230, 204, 206 can be an inward-facing surface of the respective vehicle sides 102, 110, 120, 130, 104, 106. In another embodiment, the showroom sides 202, 210, 220, 230, 204, 206 can each be a thin flat wall or panel, but with sufficient thickness and strength to form a wall of the showroom 200, and are separate from, but coupled to (such as by metal or wood framing), the vehicle sides 102, 110, 120, 130, 104, 106.

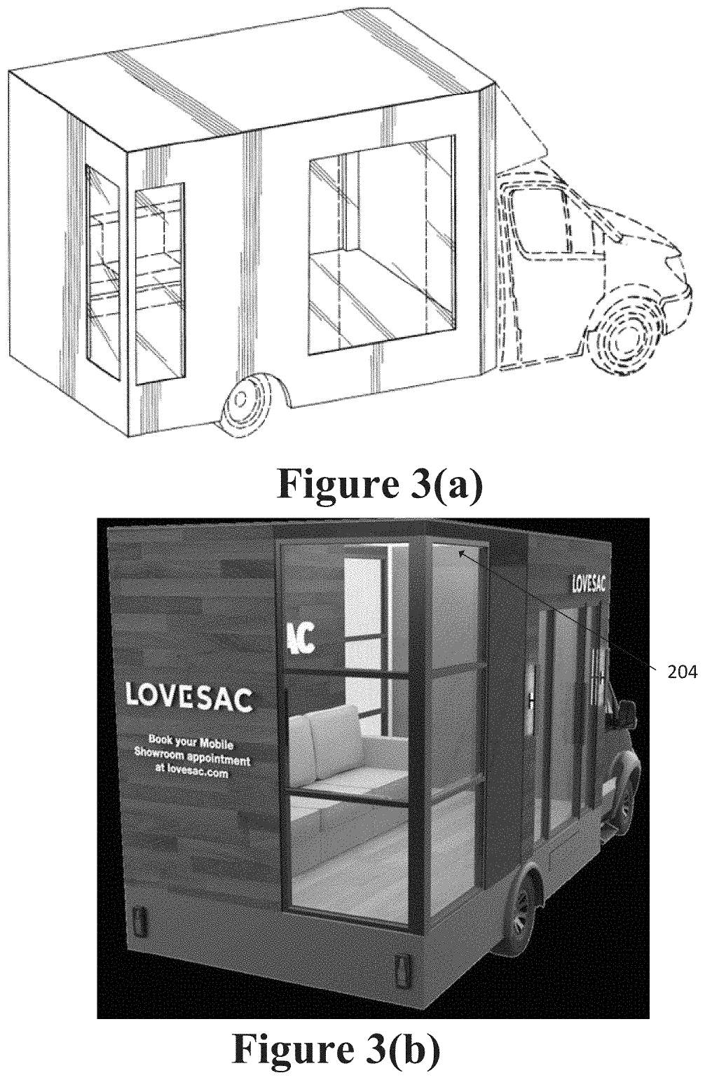

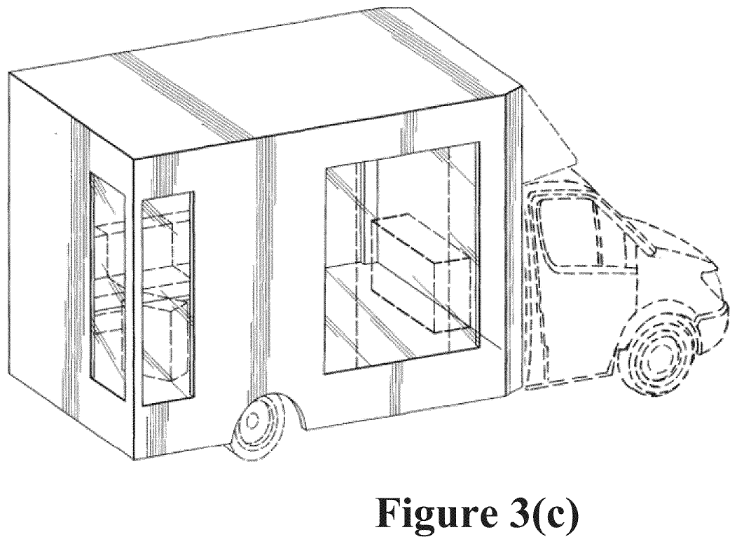

As further illustrated in FIGS. 3(c), 4(c), 6(b), one or more product or display items 250 are positioned inside the interior space 201. For example, the product can include a couch 252, table 254, television 256 and painting 258.

Referring to FIGS. 1-5, 6(b), the right side 110, 210, rear 120, 220, and left side 130, 230 have one or more viewing mechanisms 300, such as glass doors and/or windows that are positioned to display the product 250 located inside the vehicle. Each of the viewing mechanisms 300 can be elongated and rectangular in shape and configured to maximize the viewing area of the interior. The viewing mechanisms 300 are positioned in the vehicle sides 110, 120, 130 and showroom sides 210, 220, 230.

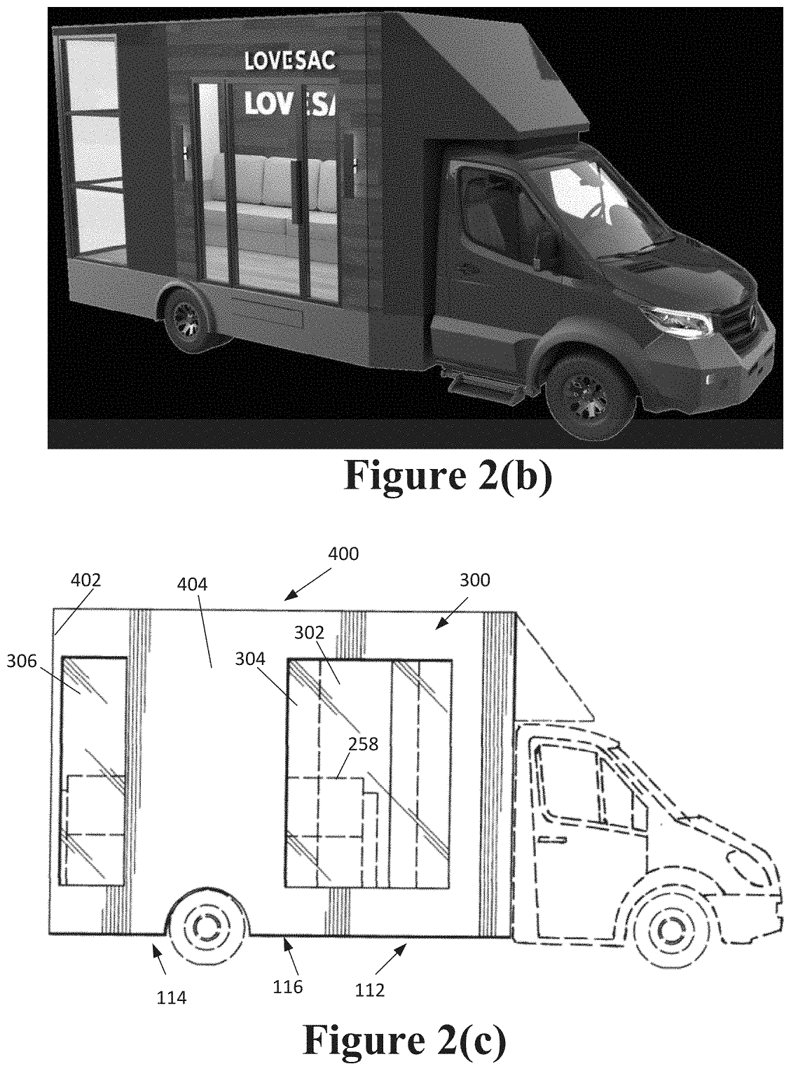

For example, the viewing mechanisms 300, such as a door 302, panel 304 or window 306, can extend substantially the entire height of the respective side, from the floor 206 to the ceiling 204. That better enables a customer outside the vehicle body to see inside the showroom 200 from a lower position and from a raised position. For example, referring to FIG. 2(c), the right side 110, 210 has a front portion 112, a rear portion 114, and an intermediate or mid-portion 116 between the front and rear portions 112, 114. A glass door 302 is positioned at the front and mid portions 112, 116 of the right side 110, 210. A glass panel 304 can be located to each side of the door 302 to further expand the viewing area. The panel 304 is fixedly closed and cannot open. The door 302 has a handle to open (FIG. 1) and close (FIG. 2(b)) the door 302. The door 302 can be part of a door assembly that includes a door frame and optional panel frames, as shown.

In addition, a glass window 306 is positioned at the rear portion 114 of the right side 110, 210. The door 302, panels 304 and window 306 enable a user to see the product 250, here the couch 252, from the outside of the vehicle, namely to the right side of the vehicle. In addition, the user can enter the showroom 200, and the door 302, panels 304 and window 306 allow natural light to enter the showroom 200, while still enabling the showroom 200 to resemble a living space such as a living room.

The right side 110 also has one or more structural features 400, including a corner posts or frames 402 and a central structural wall 404. The vehicle body 100 has framing that includes corner posts 402 at each of the four corners of the showroom 200 of the vehicle body 100, as well as cross-members that extend at least along the top of each side 102, 110, 120, 130 between the corner posts. Those corner posts 402 can be metal or wood. The right structural wall 404 is positioned between the door and panel assembly 302, 304, and the rear window 306, which is at the mid-portion of the right side 110, 210. The right structural wall 404 operates to provide structure at the interior 201 of the showroom 200 so that the interior 201 more closely resembles a living space. That can be further enhanced by positioning a display item, such as painting 258, on the interior of the showroom wall 210.

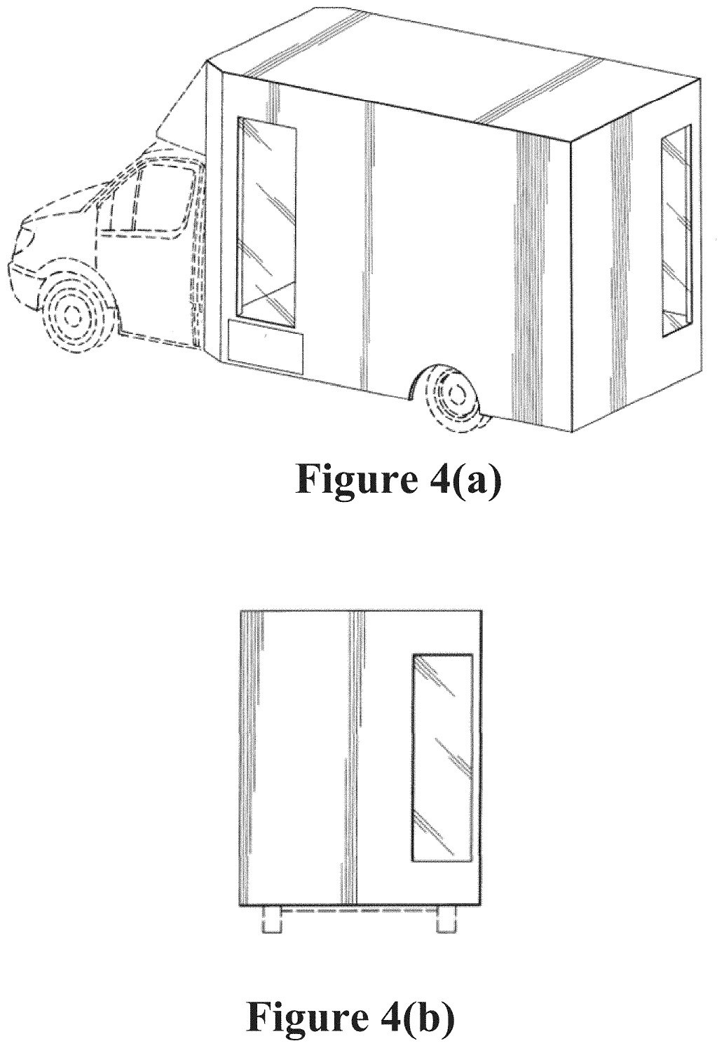

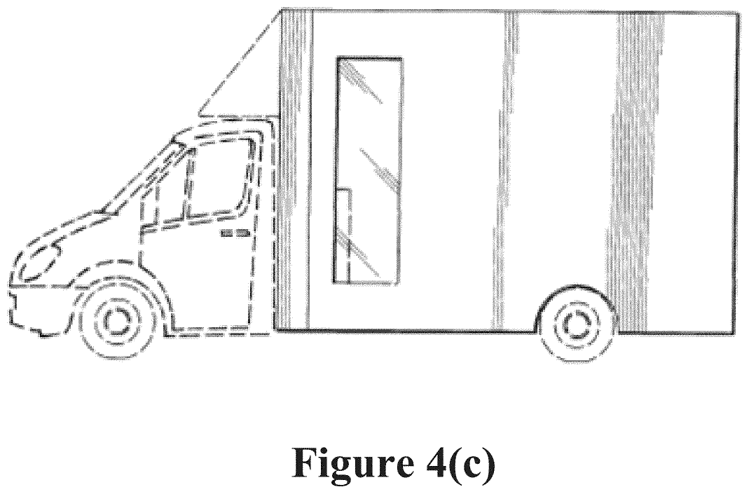

Turning to FIGS. 3(a), 3(b), 4(a), 4(b), the rear side 120, 220 of the vehicle is shown having a viewing feature and a structural feature. In particular, a rear window is positioned at the right side portion of the rear side 120, 220, and a rear structural wall is positioned at the mid and left side portions of the rear side 120, 220. As best shown in FIG. 6(b), the couch 252 can be positioned up against the rear wall. The rear window is immediately adjacent the corner post 402 and cooperates with the window 306 on the right side 110, 210, which is also positioned immediately adjacent to the corner post 402, so that the two windows are separated by the corner post 402. The windows can also have window frames, as shown.

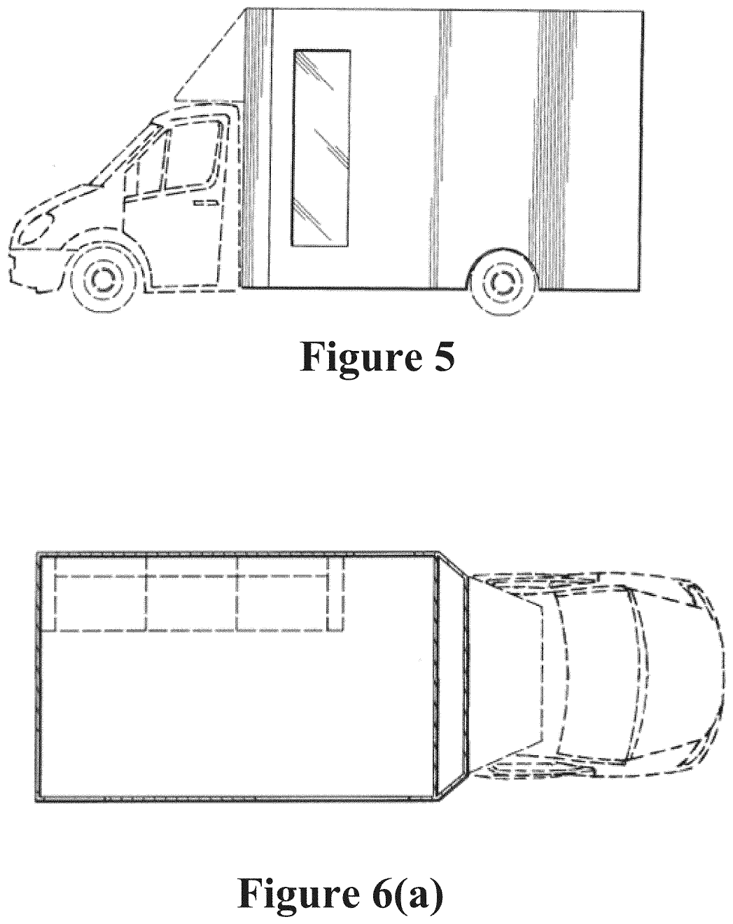

Referring now to FIGS. 4(a), 5, the left side 130, 230 of the vehicle body 100 is shown. Again, the left side 130, 230 has both structural features and viewing features, here shown as a window along the left portion and a left structural wall along the mid and right portions. As best shown in FIG. 6(b), the couch 252 extends along the interior of the left structural wall to resemble a realistic living space. The window is positioned to the side of the couch 252 and enables customers to see the showroom interior from a left area of the vehicle body 100.

As further shown in FIG. 6(b), the front side 102, 202 is a completely solid front structural wall, and a display item, such as table 254, can be positioned against the solid wall.

As further illustrated the walls are solid opaque walls and the viewing features are transparent glass or plastic. The couch is situated in a left (passenger side) corner against the rear solid wall portion and the left solid wall portion, and the glass panels are formed in the left and rear walls adjacent to the rear and left solid wall portions. Accordingly, the showroom is configured so that left and rear solid wall portions can receive the couch, which is positioned directly against the left and rear solid wall portions at a left corner of the showroom. And, glass windows or panels are positioned adjacent to the rear and left solid wall portions, at both sides of the couch. In addition, the glass door 302 and right side glass panel 304 are positioned opposite the couch. Accordingly, the showroom is configured to have solid wall portions at the couch, and glass viewing features all about the couch so that the couch is visible to viewers outside of the showroom. In addition, a solid wall portion is provided for hanging a picture opposite the couch, and the television and table are positioned inside the showroom, so that the showroom resembles a living room. The table and television display item (which resembles a television) can also be positioned to be viewable through one or more of the viewing features from outside the showroom without obstructing the couch, which is the main display item. In addition, the couch is positioned along the driver's side of the vehicle so that the glass door can be positioned at the passenger's side of the vehicle to allow easy entry and exit to a sidewalk or the like without obstructing traffic.

It is noted that viewing features are provided at three sides 110, 210, 120, 220, 130, 230 of the vehicle body 100. However, viewing features can be provided at one side or more. In addition, viewing features can be provided at the front side 102, 202, especially in embodiments where the cab 20 is removable from the vehicle body 100. Viewing features can also be provided in the top 104, 204.

In addition, portable or retractable stairs and/or a platform can be provided at the door 302 to facilitate customers entering and exiting the door 302.

It is further noted that the configuration of the showroom 200 and vehicle body 100 (e.g., the viewing features 300 and/or the structural features 400) is based on the structure of the item(s) being displayed. For example, the size, location and shape of the viewing features 300, structural features 300, sides 102, 202, 110, 210, 120, 220, 130, 230, 104, 106 can be adjusted based on the size, location and shape of the product(s) being displayed in the showroom 200 of the vehicle body 100. And, the viewing features 300 and structural features 300 need not be rectangular or linear, but can have any suitable shape such as being curved.

In addition, while the main product being displayed is shown as a couch 252, it will be apparent that any item or multiple items can be displayed in the showroom, and the configuration of the viewing features and structural features changed to conform to the structure of the item(s) being displayed.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

As used in this specification and the appended claims, the singular forms “a”, “an” and “the” include plural referents, unless the context clearly dictates otherwise. Similarly, the adjective “another,” when used to introduce an element, is intended to mean one or more elements. The terms “comprising,” “including,” “having” and similar terms are intended to be inclusive such that there may be additional elements other than the listed elements.

It is noted that the drawings may illustrate, and the description and claims may use geometric or relational terms, such as linear, rectangular, perpendicular, left, right, front, rear, mid, central, elongated, adjacent. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

1. A mobile showroom vehicle for displaying display items, comprising:
a cab;
a vehicle body positioned behind the cab, the vehicle body comprising a front panel, rear panel, left panel, and right panel, and said vehicle body having a front portion, a rear portion and an intermediate portion between the front portion and the rear portion, said front panel, said rear panel, said left panel and said right panel forming a showroom having an interior formed by said front panel, said rear panel, said left panel and said right panel;
a first viewing feature at said right panel at a front portion of said vehicle body;
a second viewing feature at said right panel at a rear portion of said vehicle body;
a third viewing feature at said left panel at a front portion of said vehicle body;
a first structural feature between the first viewing feature and the second viewing feature, said first structure feature configured to receive a first display item at the showroom interior;
a second structural feature at said left panel at the rear portion and intermediate portion of said vehicle body, said second structural feature configured to receive a second display item at the showroom interior, whereby the second display item is visible through the first viewing feature and said second viewing feature.

2. The mobile showroom vehicle of claim 1, wherein the vehicle body comprises a trailer.

3. The mobile showroom vehicle of claim 1, wherein the first display item comprises a painting.

4. The mobile showroom vehicle of claim 1, wherein the second display item comprises a couch and said showroom is configured to resemble a living room, further comprising a television display item and a table positioned at the interior of said showroom.

5. The mobile showroom vehicle of claim 1, wherein said first viewing feature comprises a glass door, said second viewing feature comprises a first glass panel and said third viewing feature comprises a second glass panel, said first and second glass panels each extending substantially from a floor to a ceiling of the showroom.

6. The mobile showroom vehicle of claim 5, wherein said first structural feature comprises a first opaque solid panel wall and said second structural feature comprises a second opaque solid panel wall, wherein said second display item comprises a couch positioned against the second solid panel wall adjacent the third viewing feature and opposite the first and second viewing features.

7. The mobile showroom vehicle of claim 6, further comprising a fourth viewing feature comprising a glass panel at said rear panel adjacent the second viewing feature and extending substantially from the floor to the ceiling of the showroom, and a third structural feature comprising a third opaque solid wall at the rear panel adjacent the second structural feature, the second and fourth viewing features at a right rear corner of the showroom and the second and third structural features at a left rear corner of the showroom, wherein said couch is positioned at the left corner adjacent the third solid wall and adjacent the fourth viewing feature.

8. The mobile showroom vehicle of claim 7, wherein the left panel is a driver side of said vehicle and the right panel is a passenger side of said vehicle.
